(19) United States
(12) Patent Application Publication
(10) Pub. No.: US 2026/0310406 A1
(43) Pub. Date: Oct. 8, 2026

(54) ELECTRONIC SYSTEM FOR DETERMINING A MOST FREQUENT DATA VALUE FROM A PLURALITY OF ELECTRIC SIGNALS

(71) Applicant: INIVATION AG, Zürich (CH)

(72) Inventor: Ferdinando PACE, Zürich (CH)

(73) Assignee: INIVATION AG, Zürich (CH)

(21) Appl. No.: 19/108,325

(22) PCT Filed: Aug. 31, 2023
(86) PCT No.: PCT/EP2023/073922

§ 371 Date: Mar. 3, 2025

(30) Foreign Application Priority Data
Sep. 9, 2022 (EP) 22194925.8
May 4, 2023 (EP) 23171649.9

(51) Int. Cl. G06F 7/02; G06F 7/556

(52) U.S. Cl. CPC G06F 7/026; G06F 7/556

(57) ABSTRACT

The present invention relates to an electronic system for determining, during use of the electronic system, a most frequent value in a data array, A, comprising a plurality of N data values A[i], i=1, . . . , N, N≥4, each data value A[i] corresponding to a respective data signal S[i], the electronic system comprising a first electronic subsystem comprising: a signal input interface for receiving the data signals; a first set of comparators determining corresponding comparison signals representative of whether or not A[i] equals A[j]; counters COᵢ, i=1, . . . , N, for determining corresponding count signals CO[i], i=1, . . . , N, each count signal CO[i] representing the number of occurrences of the data value A[i] in the data array A; selectors comprising signal inputs SelIn1ᵢ and SelIn2ᵢ receiving respective signal sets; a select line SelLineᵢ determining which signal set to output; the selectors Selᵢ, i=1, . . . , M, are interconnected such that an output selector Selout provides as output a signal set {S[jₘₐₓ], CA[jₘₐₓ], CO[jₘₐₓ]}, 1≤jₘₐₓ≤N, that is characterized in that no other data value A[k], k=1, . . . , N, has a count CO[k] higher than the count CO[jₘₐₓ] of the data value A[jₘₐₓ]. A corresponding method is also provided.

### FIELD OF THE INVENTION

The present disclosure relates to processing of data signals in an electronic system, in particular to determining a most frequent data value among a plurality of data values corresponding to a plurality of input data signals.

### BACKGROUND OF THE INVENTION

A plurality of data signals obtained for instance from a continuously operating measuring device, such as a charge-coupled device (CCD) or a microphone, typically produces large amounts of data. The data can be obtained for many different purposes. For instance, a charge-coupled device may be used to observe changes over time in the emission of infrared radiation emitted from buildings or to record a movie. Depending on the data and the purpose, the data is processed in different ways. For instance, colours in movie frames may be adjusted to create a certain impression on viewers, and data corresponding to heat emission may be processed to determine a temperature distribution and sizes of areas corresponding to different temperature intervals. Similarly, data obtained from a microphone may require analysis, for instance to characterise the sound emission in noisy places or to identify a certain aural fingerprint, such as a specific person's voice or the sound of a window breaking, just to name a few.

### SUMMARY OF THE INVENTION

The present disclosure provides an electronic system for efficiently determining a most frequent value among a plurality of data values. This need is not met in the prior art, which does not address the problem of finding a most frequent value among a plurality of data values in an efficient and fast way. Various uses of determining the most frequent value are described below.

In a first aspect, the invention provides an electronic system for determining, during use of the electronic system, a most frequent value in a data array A comprising a plurality of/data values A[i], i=1, . . . , N, N≥4, each data value A[i] corresponding to a respective data signal S[i], i=1, . . . , N, the electronic system comprising a first electronic subsystem comprising:
(i) a signal input interface for receiving the data signals S[i], i=1, . . . , N,
(ii) a first set of comparators CA_{i,j} for determining corresponding comparison signals CA[i,j], i=1, . . . , N, j=1, . . . , N, wherein each comparison signal CA[i,j] is representative of whether or not the data value A[i] equals the data value A[j],
(iii) a set of counters COᵢ, i=1, . . . , N, for determining corresponding count signals CO[i], i=1, . . . , N, wherein each count signal CO[i] is representative of the number of occurrences of the data value A[i] among the plurality of data values A,
(iv) a set of selectors Selᵢ, i=1, . . . , M, each selector Selᵢ in the set of selectors comprising:
   a first set of signal inputs SelIn1₁; configured to receive a first signal set {S[j], CA[j], CO[j]}, where 1≤j≤and CA[j]={CA[j,1], . . . , CA[j,N]}, and
   a second set of signal inputs SelIn2₂; configured to receive a second signal set {S[k], CA[k], CO[k]}, where 1≤k≤N, k≠j,
   a select line SelLineᵢ for receiving a selection signal SelSigᵢ representing whether or not CO[j]>CO[k] as determined by a corresponding select line comparator,
   a set of signal outputs SelOutᵢ, the selector Selᵢ being configured to output the signal set {S[j], CA[i], CO[j]} in case SelSigᵢ represents CO[j]>CO[k] and to output either the signal set {S[j], CA[j], CO[j]} or the signal set {S[k], CA[k], CO[k]} in case SelSigᵢ represents CO[j]≤CO[k],
the set of selectors Selᵢ, i=1, . . . , M, including an output selector Selₒᵤₜ, being interconnected such that the output selector Selₒᵤₜ provides as output signals on its set of signal outputs the signal set {S[jₘₐₓ], CA[jₘₐₓ], CO[jₘₐₓ]}, 1≤jₘₐₓ≤N, wherein the signal set {S[jₘₐₓ], CA[jₘₐₓ], CO[jₘₐₓ]} is characterized in that no other data value A[k], k=1, . . . , N, has a count CO[k]that is higher than the count CO[jₘₐₓ] of the data value A[jₘₐₓ].

It is seen that the system above outputs either the signal set {S[j], CA[j], CO[j]} or the signal set {S[k], CA[k], CO[k]} in case SelSigᵢ represents CO[j]<CO[k]. Thus, in the case that CO[j]=CO[k], a selector Selᵢ may be configured to output either the signal set {S[j], CA[j], CO[j]} or the signal set {S[k], CA[k], CO[k]}. In some embodiments, all selectors in the set Selᵢ, i=1, . . . , M, are configured to output {S[k], CA[k], CO[k]} in case SelSigᵢ represents CO[j]=CO[k]. This configuration is used in the examples in the detailed description. In other embodiments, all selectors in the set Selᵢ, i=1, . . . , M, are configured to output {S[i], CA[], CO[i]} in case SelSigᵢ represents CO[j]=CO[k]. In yet other embodiments, one or more selectors in the set Selᵢ, i=1, . . . , M, are configured to output {S[k], CA[k], CO[k]} in case SelSigᵢ represents CO[]=CO[k], while the other selectors in the set Selᵢ, i=1, . . . , M, are configured to output {S[i], CA[i], CO[]} in case SelSigᵢ represents CO[j]=CO[k]. This is a matter of design. All the embodiments above lead to an output signal set {S[jₘₐₓ], CA[jₘₐₓ], CO[jₘₐₓ]} that is characterized in that no other data value A[k], k=1, . . . , N, has a count CO[k] that is higher than the count CO[jₘₐₓ] of the data value A[jₘₐₓ]. In other words, the choice is merely a matter of how the inventive concept is implemented.

As mentioned above, in the detailed description that follows, the electronic systems are configured to output {S[k], CA[k], CO[k]} in case CO[j]≤CO[k] (including the case CO[j]=CO[k]), that is, the signal set other than that which would be output in case the counts fulfilled CO[j]>CO[k], which is {S[j], CA[], CO[j]}.

In some embodiments, log₂(N) is an integer, and each selector of a first selector subset SelSub1ᵢ, i=1, . . . , N/2, of the set of selectors is arranged to receive a respective pair of signal sets of the N signal sets {S[j], CA[j], CO[j]}, j=1, . . . , N, on its first set of signal inputs and its second set of signal inputs, respectively, whereby the first selector subset outputs N/2 signal sets, at least one of which corresponds to the data value A[jₘₐₓ]. In some embodiments, each selector of a second selector subset SelSub2ᵢ, i=1, . . . , N/4, of the set of selectors is arranged to receive a respective pair of the N/2 signal sets output by the first selector subset SelSub1ᵢ, i=1, . . . , N/2, whereby the second selector subset outputs N/4 signal sets, at least one of which corresponds to the data value A[jₘₐₓ]. In some embodiments, N≥8 and the set of selectors further comprises one or more further selector subsets SelSubᵢ arranged in series with one another and with the second selector subset, each further selector subset providing half as many output signals sets on its signal outputs as said each further selector subset receives on its signal inputs, at least one of the output signal sets from each further selector subset corresponding to the signal set {S[jₘₐₓ], CA[jₘₐₓ], CO[jₘₐₓ]}, a final further selector subset comprising the output selector Selₒᵤₜ, whereby the signal sets {S[j], CA[j], CO[j]}, j=1, . . . , N, are progressively reduced by the electronic system to the single signal set {S[jₘₐₓ], CA[jₘₐₓ], CO[jₘₐₓ]} which is output at the signal outputs of the output selector Selₒᵤₜ.

Selectors are also known as multiplexers.

Advantageously, the number M of selectors equals N−1. This may be the lowest number required. The fact that M is equal to or greater than N−1 follows from the claimed invention: the systems/methods output the signal set {S[jₘₐₓ], CA[jₘₐₓ], CO[jₘₐₓ]} (characterized in that no other data value A[k], k=1, . . . , N, has a count CO[k] that is higher than the count CO[jₘₐₓ] of the data value A[jₘₐₓ]), and for this to be achieved, at least N−1 selectors are required, as each selector discards one signal set. In all the examples presented in the detailed description, M equals N−1.

In some embodiments, the set of selectors comprises a first selector SelCasc₁ arranged to receive a first pair of signal sets of the signal sets {S[j], CA[j], CO[j]}, j=1, . . . , N, the set of selectors further comprising a set of further selectors SelCascᵢ, i=2, . . . , N−1, each of the further selectors SelCascᵢ, i=2, . . . , N−1, being arranged to receive the output signals from a preceding selector SelCascᵢ₋₁, i=2, . . . , N−1, on its first set of signal inputs and to receive, on its second set of signal inputs, a signal set among {S[j], CA[j], CO[j]}, j=1, . . . , N, that has not been provided as input to the set of selectors, until all signal sets have been provided as input to a selector of the set of selectors, whereby the signal set {S[jₘₐₓ], CA[jₘₐₓ], CO[jₘₐₓ]} is provided as output on the signal outputs of the selector SelCasc_{N-1} of the set of selectors.

In some embodiments, the electronic system further comprises:
an image sensor comprising a plurality of pixels p[i], i=1, . . . , I, I≥4, for capturing an image signal, the image signal representing a set of intensity values I[i], i=1, . . . , I, each intensity value I[i], i=1, . . . , I, representing an amount of radiation captured by a corresponding pixel p[i], i=1, . . . , I, of the image sensor,
an analogue-to-digital interface (ADC), the ADC being arranged to receive the image signal from the image sensor and to provide a corresponding digital image signal representing the intensity values I[i], i=1, . . . , I, captured by the corresponding pixels p[i], i=1, . . . , I, in the image sensor, the ADC further comprising an ADC output interface connected to the signal input interface to provide at least a part of the digital image signal to the first electronic subsystem.

Image sensors typically collect light for a relatively short period of time in order to maintain a dynamic range in the amount of radiation captured by different pixels. If the capture time is too long, the image sensor is eventually saturated and will not represent the subject to be imaged. This is well known. It is therefore implicit that the image sensor is operated in such a way as to present the subject to be imaged. In low-light conditions, a longer exposure time may be required, and in conditions with a lot of radiation, the exposure time may require a relative short exposure time.

The image sensor may be particularly sensitive for instance to light having one or more wavelengths in the range 200-15000 nm, such as in the range 200-3000 nm, such as in the range 300-3000 nm, such as in the range 200-300 nm or in the range 300-380 nm or in the range 380-750 nm or in the range 750-3000 nm or in the range 3000-6000 nm or in the range 6000-15000 nm, or in a range overlapping two of these ranges, for instance in the range 600 -1600 nm.

In some embodiments, the ADC is configured to output, on the ADC output interface, a part of the digital image signal corresponding to N of the intensity values in parallel. In some embodiments, the extracted N intensity values from the intensity values I[i], i=1, . . . , I, correspond to a subset of N pixels that are contiguously arranged in the image sensor. In some embodiments, the N pixels p[i] are arranged in a two-dimensional array of L×P pixels, where L,P≥2, such as L,P≥3, such as L,P≥4. In some embodiments, L=P. In some embodiments, log(L) and/or log(P) is a positive integer,

In some embodiments, the ADC is further configured to sequentially provide the intensity values I[i], i=1, . . . , I, in blocks of N intensity values to the first electronic subsystem, the electronic system further comprising a transmitter system coupled to the first electronic subsystem and being configured to receive the output signals from the output selector Selₒᵤₜ, the transmitter system further being configured to provide a transmission signal T comprising a first signal portion T₁ that represents the most frequent value A[jₘₐₓ]. In some embodiments, the transmission signal T comprises a second signal portion T₂ representing the count CO[jₘₐₓ]. In some embodiments, the transmission signal T comprises a second signal portion T₂ representing the comparison array CA[jₘₐₓ]. In some embodiments, the transmission signal T comprises a third signal portion T₃ representing the data values of the data array A other than the most frequent value A[jₘₐₓ].

In some embodiments, the first electronic subsystem is comprised in an application-specific integrated circuit (ASIC) comprising:
(i) the signal input interface,
(ii) the first set of comparators,
(iii) the set of counters,
(iv) the set of selectors,
(v) the select line comparators, and
(vi) a signal output interface configured to provide the output signals {S[jₘₐₓ], CA[jₘₐₓ], CO[jₘₐₓ]} from the output selector Selₒᵤₜ.

A second aspect of the invention provides an ASIC, the ASIC comprising:
(i) the signal input interface,
(ii) the first set of comparators,
(iii) the set of counters,
(iv) the set of selectors,
(v) the select line comparators, and
(vi) a signal output interface configured to provide the output signals {S[jₘₐₓ], CA[jₘₐₓ], CO[jₘₐₓ]} from the output selector Selₒᵤₜ.

A third aspect of the invention provides an ASIC, the ASIC comprising an electronic system in accordance with the first aspect of the invention.

The signal input interface and/or the signal output interface may be externally accessible, such as for integration, for instance by soldering, on a printed circuit board. In some embodiments, the ASIC comprises a plurality of first electronic subsystems.

In the description below, the terms data signal S and data array A are used interchangeably, since the plurality of signals S[i] correspond to the plurality of data values A[i], but the data signals S are physical signals that have physical characteristics, such as amplitudes, that represent the data value, but they do not “have a value” as such. This is well known to the person skilled in the art. For instance, data signal S[1] is typically a continuous signal that changes in accordance with the input received on the signal input interface. The characteristic, such as the amplitude of the data signal, changes over time, reflecting a certain data value being received, such as the data value 6. However, reference to comparisons of data signals rather than the corresponding data values is much less intuitive and would unnecessarily complicate the claims as well as the description of the invention. The plurality of data values A[i], i=1, . . . , N are interchangeably referred to as the data values A. Similarly, the data signals S[i], i=1, . . . , N are interchangeably referred to as the data signals S.

The same applies to the comparison signals, which are interchangeably referred to as comparison array to emphasize the values that the comparison signals represent. Similarly, the count signals are interchangeably referred to as counts or count array to emphasize the values that the count signals represent.

In a fourth aspect, the invention provides a method for determining a most frequent value in a data array A comprising a plurality of/data values A[i], i=1, . . . , N, N≥4, each data value A[i] corresponding to a respective data signal S[i], i=1, . . . , N, the method being carried out in an electronic system, the method comprising steps of:
(i) receiving the data signals S[i], i=1, . . . , N, on a signal input interface of the electronic system,
(ii) determining a set of comparison signals CA[i,j], i=1, . . . , N, j=1, . . . , N, wherein each comparison signal CA[i,j] is representative of whether or not the data value A[i] equals the data value A[j],
(iii) determining a set of count signals CO[i], i=1, . . . , N, wherein each count signal CO[i] is representative of the number of occurrences of the data value A[i] among the plurality of data values A; the data signals, the comparison signals, and the count signals forming a plurality of signal sets {S[i], CA[i], CO[i]}, i=1, . . . , N, where CA[i]={CA[i,1], . . . , CA[i,N]},
(iv) in a set of selectors, carrying out a number of signal selections, wherein each of the signal sets {S[i], CA[i], CO[i]}, i=1, . . . , N, is selected or discarded based on a comparison with at least one other signal set {S[j], CA[j], CO[j]}, 1≤j≤N, i≠j, wherein the comparison is based on the respective counts CO[i] and CO[j], each selection comprising:
   in case CO[i]>CO[j], selecting the signal set {S[i], CA[i], CO[i]} for comparison with another signal set {S[k], CA[k], CO[k]}, i≠j≠k, and discarding the signal set {S[j], CA[i], CO[i]}, or
   in case CO[i]<CO[j], selecting one of the signal sets {S[i], CA[i], co[i]} and {S[i], CA[], CO[j]} for comparison with another signal set {S[k], CA[k], CO[k]}, 1≤k≤N, i≠j≠k, and discarding the other of the signal sets {S[i], CA[i], CO[i]} and {S[j], CA[j], CO[j]},
(v) continuing step (iv) until all except a single signal set {S[jₘₐₓ], CA[jₘₐₓ], CO[jₘₐₓ]}, 1≤jₘₐₓ≤N, have been discarded in one of the comparisons, and
(vi) providing the signal set {S[jₘₐₓ], CA[jₘₐₓ], CO[jₘₐₓ]} on a signal output interface of the electronic system.

Similarly to electronic systems in accordance with the first aspect of the invention, methods in accordance with the invention provide an output signal corresponding to a most frequent data value A[jₘₐₓ] among N data values A corresponding to respective data signals S.

In a fifth aspect, the invention provides an electronic system, such as an ASIC, configured such as to carry out a method in accordance with the fourth aspect of the invention.

The considerations described above in relation to the first aspect apply equally to the second aspect, the third aspect, the fourth aspect, and the fifth aspect. For instance, the data signals S could be signals originating from an image sensor. As an example, the data signals S correspond to respective N signals captured by an image sensor, and each of the N signals represents an amount of radiation captured by respective N pixels in the image sensor, such as N contiguous pixel in the image sensor.

Similarly, the number N of data signals may be even. In some embodiments, log₂(N) is an integer.

### BRIEF DESCRIPTION OF THE FIGURES

Embodiments of the disclosure will be described in more detail in the following with regard to the accompanying figures. The figures show exemplary ways of implementing the invention and are not to be construed as being limiting the scope of protection to those exemplary implementations.

FIGS. 1a-1d illustrate an electronic system in accordance with an aspect of the invention, and a method of operating the electronic system.

FIG. 2 illustrates another electronic system in accordance with the invention.

FIGS. 3a-3e illustrate another electronic system in accordance with an aspect of the invention, and a method of operating the electronic system.

FIG. 4 illustrates another electronic system in accordance with an aspect of the invention, the electronic system including a CCD obtaining data for processing.

FIG. 5 illustrates another electronic system in accordance with an aspect of the invention, the electronic system including a CCD obtaining data for processing.

FIGS. 6a-6e illustrate different transmission portions that can be transmitted based on the output of the output selector.

### DETAILED DESCRIPTION OF SELECTED EMBODIMENTS

Various exemplary embodiments and details are described hereinafter, in some cases with reference to the figures. It should be noted that the figures may or may not be drawn to scale and that elements of similar structure or function may be represented by like references in different figures. The figures are intended to facilitate the description of the embodiments. They do not provide an exhaustive description of the invention and they shall not be construed as limiting the scope of protection.

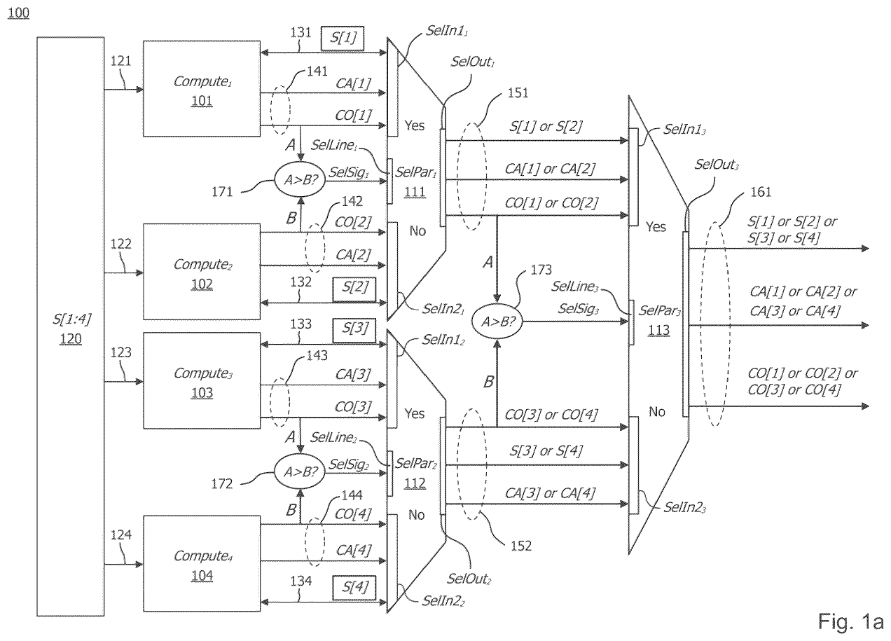

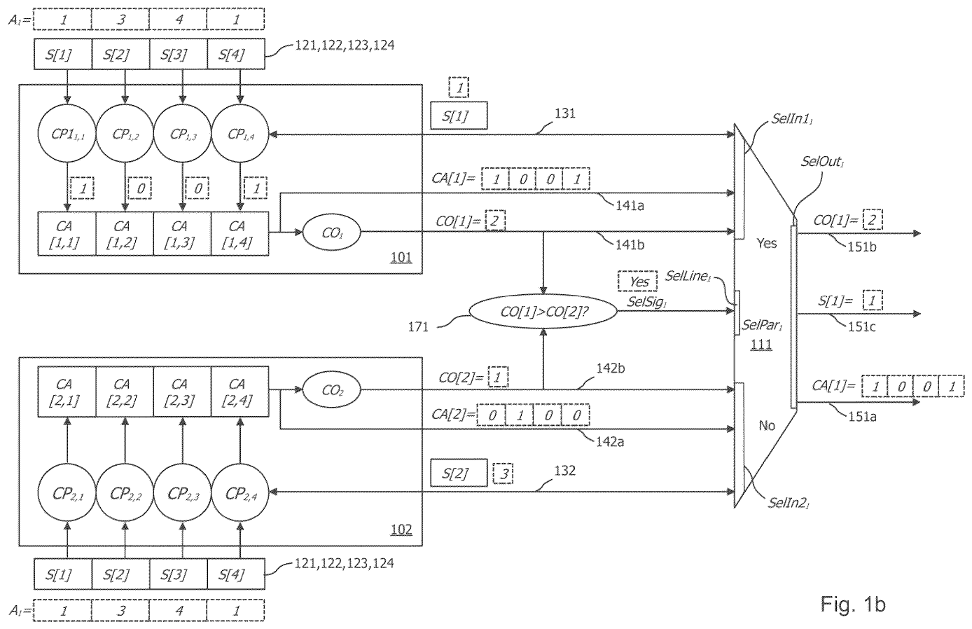

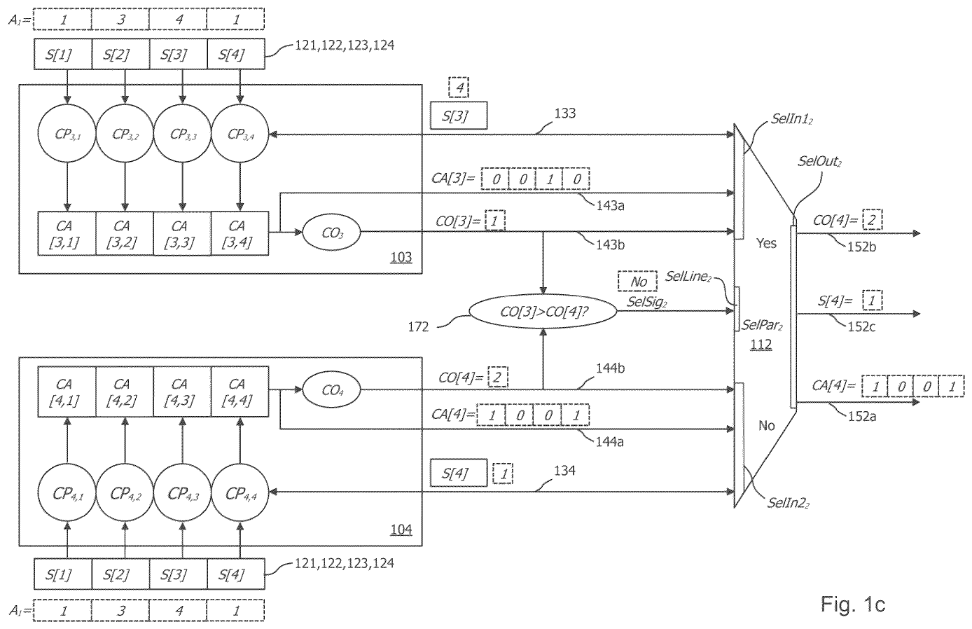

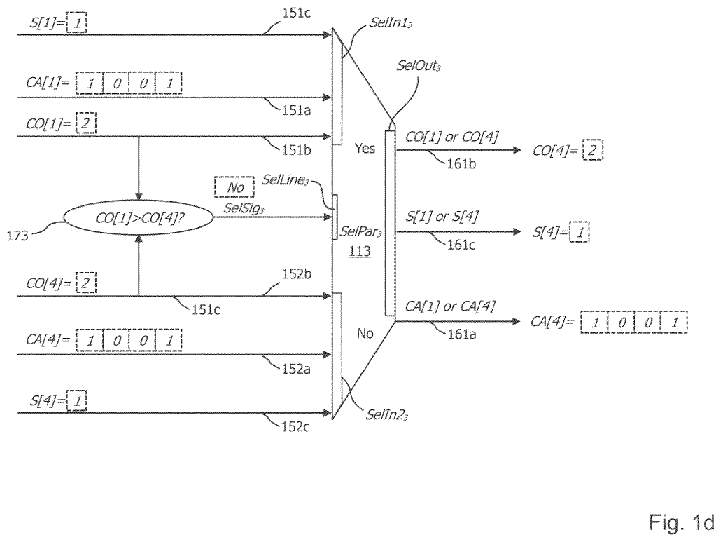

FIGS. 1a-1d illustrate an electronic system 100 in accordance with the invention. The electronic system includes a signal input interface 120 for receiving a plurality of data signals, S, in this case four data signals. The electronic system further comprises a set of 4 computing units Compute₁, i=1, . . . , 4, (101, 102, 103, 104) that perform processing of the data signals. The plurality of data signals S[1], S[2], S[3], and S[4], are provided to each computing unit over respective signal lines (interconnections) 121, 122, 123, and 124. That is, each computing unit receives all 4 data signals.

The term signal is used interchangeably with the terms signal line and input line and output line because each signal line is associated with a particular signal during operation of the electronic system. For instance, signal S[1] is associated with line 121, S[2] is associated with line 122, and so on. In some cases, a signal line connects two elements, and depending on the perspective, the output signal from one element is the input signal to the other element.

The computing units Compute₁ for processing the data signals are discussed in more detail in relation to FIGS. 1b-1c below. Each computing unit Compute further receives a respective one of the data signals, S, on a corresponding input line 131, 132, 133, 134. Compute₁ receives S[1] over line 131, Compute₂ receives S[2] over line 132, and so on.

Outputs signals from the respective computing units Compute₁ are provided on lines 141, 142, 143, 144 connecting respective computing units to signal inputs on selectors SelPar₁ and SelPar₂. of a set of selectors SelParᵢ. i=1, . . . , 3. Each selector SelParᵢ has two inputs, SelIn1ᵢ and SelIn2ᵢ). Each input is configured to receive one of the data signals, S[i], a corresponding comparison signal CA[i], and a corresponding count signal CO[i]. The signals CA[i] and CO[i] are described in more detail in relation to FIG. 1b.

In the example in FIG. 1a, selector SelPar₁ receives, on signal input SelIn1₁, the data signal S[1] over line 131. The data signal S[1] is received via the signal input interface 120, together with the other data signals S[2], S[3], and S[4], but is provided to the computing unit Compute₁ twice, as shown. The selector SelPar₁ further receives, on signal input SelIn1₁, a comparison signal CA[1] and a count signal CO[1] contained in a signal 141 provided by the computing unit Compute₁, as shown in FIG. 1a.

Furthermore, selector SelPar₁ receives data signal S[2] of the plurality of data signals, S, on signal input SelIn2₁ received on signal input interface 120. The selector SelPar₁ further receives, on signal input SelIn2₁, a corresponding comparison signal CA[2] and a corresponding count signal CO[2] contained in a signal 142 provided by the computing unit Compute₂.

The selector SelPar₁ further comprises an output SelOut₁ for outputting either of the set of signals {S[1], CA[1], CO[1]} or the set of signals {S[2], CA[2], CO[2]}. The output is decided based on a select signal SelSig₁ received on a select line SelLine₁ in the selector SelPar₁. In this example, if the select signal SelSig₁ corresponds to a “true” indication, the selector SelPar₁ outputs the signal set {S[1], CA[1], CO[1]} (corresponding to the “Yes” branch), whereas if the select signal SelSig₁ corresponds to a “false” indication, the selector SelPar₁ outputs the signal set {S[2], CA[2], CO[2]} (corresponding to the “No” branch).

The select signal SelSig₁ is determined based on a comparison of two counts in a comparator 171. More specifically, the comparator 171 compares the count signal CO[1] from the computing unit Compute₁ with the count signal CO[2] from the computing unit Compute₂. As will be explained in more detail in relation to FIGS. 1b and 1c below, each count signal CO[i] represents a frequency of the data value A[i] among the plurality of data values A. The selected set of data signals {S[1], CA[1], CO[1]} or {S[2], CA[2], CO[2]}, selected in dependence on the select signal SelSig₁, is output as output signals 151 on a selector output SelOut₁ of the selector SelPar₁. As indicated in FIG. 1a, the output on the three output lines 151 are, respectively, either S[1] or S[2], CA[1] or CA[2], and CO[1] or CO[2], depending on the select signal SelSig₁ as explained above.

Similarly, selector SelPar₂ receives data signal S[3] of the plurality of data signals, S, on signal input SelIn1₂ via line 133. The data signal S[3] is received via the signal input interface 120, as explained above. The selector SelPar₂ further receives, on signal input SelIn1₂, a comparison signal CA[3] and a count signal CO[3]from the computing unit Compute₃, obtained based on the data signals S as described in more detail in relation to FIG. 1c.

Selector SelPar₂ furthermore receives data signal S[4] of the plurality of data signals, S, on signal input SelIn2₂ via line 134. The selector SelPar₂ further receives, on signal input SelIn2₂, a comparison signal CA[4]and a count signal CO[4]from the computing unit Compute₄ as described in more detail in relation to FIG. 1c.

Similarly to the selector SelPar₁, the selector SelPar₂ further comprises an output SelOut₂ for outputting either the signal set {S[3], CA[3], CO[3]} or the signal set {S[4], CA[4], CO[4]} on three output lines 152. The output is decided based on a select signal SelSig₂ received on select line SelLine₂ of the selector SelPar₂. If the select signal SelSig₂ corresponds to a “true” indication, the selector SelPar₂ outputs the signal set {S[3], CA[3], CO[3]} (corresponding to the “Yes” branch), whereas if the select signal SelSig₂ corresponds to a “false” indication, the selector SelPar₂ outputs the signal set {S[4], CA[4], CO[4]} (corresponding to the “No” branch).

Similarly to the select signal SelSig₁, the select signal SelSig₂ is determined based on a comparison of two values in a comparator, in this case comparator 172. The comparator 172 compares the count signal CO[3]from the computing unit Compute₃ with the count signal CO[4]from the computing unit Compute₄. As will be explained in more detail in relation to FIG. 1c below, the count signals CO[3] and CO[4] correspond, respectively, to a frequency of the data values A[3] and A[4] in the data array A.

As indicated in FIG. 1a, the output signals from SelPar₂ on each of the three lines 152 is either S[3] or S[4], CA[3] or CA[4], and CO[3] or CO[4], respectively, depending on the select signal SelSig₂ as explained above.

Since the outputs SelOut₁ and SelOut₂ correspond to the signal set having the highest count, CO[1] or CO[2] from SelOut₁ and CO[3] or CO[4] from SelOut₂, the most frequent data value will correspond to either output signals 151 or output signals 152. These signals are input to respective signal inputs, SelIn1₃ and SelIn2₃ on a third selector, SelPar₃. The selector SelPar₃ performs the same kind of process as selectors SelPar₁ and SelPar₂. The select line SelLine₃ of selector SelPar₃ receives a signal from comparator 173 that compares the count signals of the two respective signal sets input to the selector. If the count in the signal set provided on the upper signal input SelIn1₃ is higher than the count in the signal set provided on the lower signal input SelIn2₃, then the signal set input on signal input SelIn1₃ is output on the output SelOut₃ of the selector SelPar₃, illustrated by signals 161. If the count in the signal set provided on the upper signal input SelIn1₃ is not higher than the count provided on the power input SelIn2₃, then the signal set input on signal input SelIn2₃ is output on the output SelOut₃ of the selector SelPar₃, illustrated by signals 161. This is illustrated in more detail below.

In accordance with the invention, the selector SelPar₁ in the present example acts as an output selector, since there are no more signal sets to compare. The invention ensures this by making sure that all signal sets {S[i], CA[i], CO[i]} have been compared to another signal set, and in such a way that the output signal set, corresponding to signals 161 in FIG. 1a, is a signal set for which the data value A[jₘₐₓ] is characterised in that no other data values in the data array A have a higher frequency (count) than that of data value A[jₘₐₓ]. This can be achieved in different ways. The method described in FIGS. 1a-1d uses what may be seen as a “parallel” configuration in that it evaluates the signal sets pairwise in parallel. As seen in FIG. 1a and from the description above, signal sets {S[1], CA[1], CO[1]} and {S[2], CA[2], CO[2]} are evaluated in SelPar₁ 111 temporally overlapping with evaluating {S[3], CA[3], CO[3]} and {S[4], CA[4], CO[4]} in SelPar₂ 112. This allows the signal sets selected in SelPar₁ and SelPar₂, respectively, and represented by signals 151 and 152, respectively, to reach the signal inputs SelIn1₃ and SelIn2₃ of selector SelPar₃ temporally overlapping for evaluation in that selector. It will be readily appreciated by the person skilled in the art, once privy to the present disclosure, that the computing units, selectors, and interconnections, such as the transmission lines connecting the different functional elements, are configured to ensure that the signal processing occurs as described above. In other words, the electronic system is configured such that pairs of signal sets to be evaluated in respective selectors arrive overlappingly (in a sense: “sufficiently simultaneously”) to allow the selecting to be performed as described between corresponding signals. Similarly, the select line comparators and select lines associated with the different selectors are configured such as to ensure that the selection can occur. If a select line signal, such as SegSig₁, arrives either too early or too late compared to the signals input to the selector, the output of selector SelPar₁ will at best be unreliable. As mentioned above, these points are readily appreciated by the person skilled in the art and it is therefore implicit that the transmission and processing times are adapted as described just above.

FIG. 1b illustrates in more detail the signal processing taking place in the computing units Compute₁ and Compute₂ of the electronic system 100 shown in FIG. 1a.

As is seen from FIG. 1b, each of the computing units Compute₁ and Compute₂ receives the plurality of data signals S, as well as a respective individual data signal S[i] as also described above.

As shown in FIG. 1b, Compute₁ receives all 4 data signals and individually also data signal S[1]. Computing unit Compute₁ comprises a set of comparators CP_{1,1}, CP_{1,2}, CP_{1,3}, CP_{1,4}, each of which compares the individual data signal S[1] with each of the data signals S[1], S[2], S[3], and S[4] to determine whether the plurality of signals corresponds to the individual value S[1] or not. In the example, the data signals S represent a set of data values A₁={1, 3, 4, 1}.

The comparator CP_{1,1} compares S[1] received via line 131 with S[1] from the plurality of data signals received via line 121. This line, like lines 132-134, is preferably connected to the signal input interface 120, as this will reduce the number of inputs, such as pins, required to process the plurality of data signals S.

The comparison results in a comparison signal CA[1,1]. The comparison signal CA[1,1] is indicated with a value of “1”, which represents equality between the compared values. In an actual circuit, as also discussed above, signals are physical signals having a characteristic that represents a value. For instance, the comparison signal may be a current or voltage having an amplitude that represents that the two values being equal. Similarly, “0” will be used here to indicate that a comparison is made between two values that are not equal. The characteristic of the comparison signal will be different from the characteristic corresponding to the values being equal.

Comparator CP_{1,2} compares S[1] received via signal line 131 with S[2] from the plurality of data signals S received via line 121. That is, the value 1 is compared to the value 3. The comparison results in a comparison signal CA[1,2]. The comparison signal CA[1,2] is indicated with a “0” to indicate that the two values are not equal. In an actual electronic system, the output signals from the compactors CP_{1,1} and CP_{1,2} are different since one comparison evaluates to true and the other evaluates to false.

Similarly, comparator CP_{1,3} compares S[1] with S[3], i.e. the value 1 is compared to the value 4. The comparison results in a comparison signal CA[1,3] indicated with a “0” to indicate that S[1] is different from S[3].

Finally, comparator CP_{1,4} compares S[1] with S[4], i.e. the value 1 is compared to the value 1. The comparison results in a comparison signal CA[1,4] indicated with a “1” to indicate that S[1] is equal to S[4].

The comparisons result in four comparison signals CA[1,1], CA[1,2], CA[1,3], and CA[1,4], which in FIGS. 1a and 1b for simplicity are referred to as CA[1]. As described and shown in relation to FIG. 1a, the comparison signal CA[1] is output from the computing unit Compute₁ and provided as input to the selector SelPar₁ on the signal input SelSig1₁ via a line 141a as shown in FIG. 1b. The comparison signal CA[1]is an “array of signals” and is indicated as CA[1]={1, 0, 0, 1} in FIG. 1b, representing the different comparisons in the computing unit Compute₁ described above.

The computing unit Compute₁ also performs a counting based on the comparison signal CA[1] (containing 4 signals). A counter CO₁ counts the number of “1”'s in the comparison signal CA[1], resulting in the count signal CO[1] described in relation to FIG. 1a. Since the data signal S represents the data value 1 twice (in other words, the data value 1 occurs twice in the data array A), the count signal CO[1] represents a count of 2 (as discussed above in relation to the comparison signals, the count signal is an electrical signal with characteristics that represent that the value 1 is represented twice in the data array A).

As shown in FIG. 1b, the comparison signal CA[1] and a count signal CO[1] are provided on the signal lines 141a and 141b, respectively, which are coupled to signal inputs SelIn₁ of the selector SelPar₁.

Similarly, computing unit Compute₂ receives all 4 data signals S[i], i=1, . . . , 4 via signal line 122 and the individual data signal S[2] on signal line 132. Like Compute₁, Compute₂ comprises a set of comparators CP_{2,1}, CP_{2,2}, CP_{2,3}, CP_{2,4}, each of which compares the individual data signal S[2] with each of the data signals S[1], S[2], S[3], and S[4], respectively, to determine whether the data signals correspond to the same data value A[2] or not.

In more detail, the comparator CP_{2,1} in Compute₂ compares S[1]with S[2], i.e. the value 1 is compared to the value 3. The individual signal S[2] from signal line 132 is input on a separate signal, which is preferably connected to the signal input interface 120, as this will reduce the number of inputs, such as pins, required, as also described above in relation to Compute₁.

The comparison results in a comparison signal CA[2,1], which corresponds to “0” because the two corresponding values A[1] and A[2] are different.

The comparator CP_{2,2} in Compute₂ compares S[2] with S[2], i.e. the value 3 is compared to the value 3, which results in a comparison signal “1”. Comparator CP_{2,3} compares values 4 and 3, resulting in a comparison signal CA[2,3] corresponding to “0”, since the values 4 and 3 are different. Finally, comparator CP_{2,4} compares values 1 and 3, resulting in a comparison signal CA[2,4] corresponding to “0”, since the values 1 and 3 are different.

The comparisons result in four comparison signals CA[2,1], CA[2,2], CA[2,3], and CA[2,4], which in FIGS. 1a and 1b for simplicity are referred to as CA[2]. As described in relation to FIG. 1a, the comparison signal CA[2] is output from the computing unit Compute₁ and provided as input to the selector SelPar₁, in this case on the signal input SelIn2₁ via a line 142a. As illustrated in FIG. 1b and in accordance with the description above, the comparison signal CA[2] is an array of signals corresponding having values {0, 1, 0, 0}.

Like computing unit Compute₁, the computing unit Compute₂ also performs a counting based on the comparison signal CA[2] (containing 4 signals). A counter CO₂ counts the number of “1”'s in the comparison signal CA[2]. Since the data signal S represents the data value 3(S[2 ]) once, the count signal CO[2] corresponds to 1. As discussed above in relation to count signal CO[1], count signal CO[2] is an electrical signal having properties that represent that the value 3 is represented once by the data signal S.

The comparison signal CA[2] and the count signal CO[2] are provided on lines 142a and 142b, respectively, as input to signal input SelIn2₁ of the selector SelPar₁ as described in relation to FIG. 1a.

The signal SelSig₁ on the select line SelLine₁ of selector SelPar₁ determines whether the selector SelPar₁ will output the signal set {S[1], CA[1], CO[1]} or the signal set {S[2], CA[2], CO[2]} on the signal output SelOut₁.

According to the invention, the signal SelSig₁ on the select line SelLine₁ represents the result of determining whether one count is higher than the other count, specifically whether CO[1]>CO[2] as also described in relation to FIG. 1a. Since the counter CO[1] in Compute₁ determined that the data value 1 occurred twice and the counter CO[2] in Compute₂ determined that the data value 3 occurred only once, the evaluation in comparator 171 results in “true”, and the “Yes” branch is selected, resulting in the signal set {S[1], CA[1], CO[1]} being output on the signal output SigOut₁ on signal lines 151c, 151a, and 151b, respectively, as shown in FIG. 1b.

As also described above, the different data signals S propagating from the signal inputs and through Compute₁ and Compute₂ temporally overlap in SelPar₁ so that the selection can be performed. Similarly, the provision of the count signals CO[1] and CO[2] to the comparator 171 must allow the select signal SelSig₁ to reach SelPar₁ in time for the selector to select between the data signal sets, {S[1], CA[1], CO[1]} and {S[2], CA[2], CO[2]}.

It is also noted that for simplicity, the output signals from the selectors are explained and shown as being the same as the inputs to the computing units and the selectors. For instance, as shown in Figs. 1a and 1b, the output of SelPar₁ is either {S[1], CA[1], CO[1]} or {S[2], CA[2], CO[2]}, which are identical to the signal sets provided on the signal inputs. In an actual circuit, there are losses in the transmission lines and in the selectors, and a degree of noise is imparted on the signals. Accordingly, the output data signals from SelPar₁ are different from the data signal received on the signal input interface. However, the information represented by the different signals provided on the signal inputs and output on the signal outputs is the same, and the same references are therefore used. This is also readily appreciated by the person skilled in the art, especially when privy to the present disclosure.

As a result of the process above, the signals {S[1]=1, CA[1]={1,0,0,1}, CO[1]=2} are provided on the output SelOut₁.

In parallel with the processing described above with reference to FIG. 1b, a corresponding processing takes place based on the individual data signals S[3] and S[4]. This is shown in FIG. 1c. The figure corresponds to FIG. 1b, but this part of the electronic system 100 uses computing units Compute₃ and Compute₄, each of which receives the plurality of data signals, S, via signal lines 123 and 124 (see FIG. 1a) and a respective individual data signal, S[3] and S[4], via lines 133 and 134, as shown in FIGS. 1a and 1c.

Accordingly, the description of FIG. 1c will be rather brief, as the process is much the same as the process described above in relation to FIG. 1b.

In FIG. 1c, the computing unit Compute₃ compares the data signals S received on signal line 123 with the data signal S[3] received on signal line 133. The comparisons taking place in comparators CP_{3,1}, CP_{3,2}, CP_{3,3}, and CP_{3,4} result in a comparison signal CA[3] representing comparison results {0,0,1,0}. These results reflect that the data value corresponding to data signal S[3], namely the data value 4, only occurs in the data signal S[3]. The corresponding count signal, obtained by counter CO₃, represents the value 1, representing the single occurrence of the data value 4. That is, the number of “1”'s represented by the comparison signal CA[3] is 1. The comparison signal CA[3] and the count signal CO[3] are output on signal lines 143a and 143b, respectively, which are coupled to the signal input SigIn1₂ of the selector SelPar₂. The data signal S[3]is also provided to the signal input SigIn1₂ of selector SelPar₂, via signal line 133.

Similarly, the computing unit Compute₄ compares the data signals S received on signal line 124 with the data signal S[4] received on signal line 134. The comparisons taking place in comparators CP_{4,1}, CP_{4,2}, CP_{4,3}, and CP_{4,4}, result in a comparison signal CA[4] representing comparison results {1,0,0,1}. These results reflect that the data value of data signal S[4], namely the data value 1, corresponds to the data signal S[1] and the data signal S[4]. The corresponding count signal CO[4], obtained by counter CO₄, represents the value 2, reflecting the two occurrences of the data value 1. That is, the number of “1”'s represented by the comparison signal CA[4] is 2. The comparison signal CA[4] and the count signal CO[4] are output on signal lines 144a and 144b, respectively, which are coupled to the signal input SigIn2₂ of selector SelPar₂. The data signal S[4] is also provided to the signal input SigIn2₂ of selector SelPar₂. via signal line 134.

After the signals S have been processed in the computing units Compute₄ and Compute₄, the resulting signals {S[3], CA[3], CO[3]} and {S[4], CA[4], CO[4]} are provided as inputs on signal inputs SelIn1₂ and SelIn2₂, respectively, as described above. This should occur substantially simultaneously with {S[1], CA[1], CO[1]} and {S[2], CA[2], CO[2]} being provided as inputs on signal inputs SelIn1₁ and SelIn2₁, respectively, of selector SelPar₁, in order to allow the outputs of selectors SelPar₁ and SelPar₁ to temporally overlap in SelPar_{3.}

Similarly to SelLine₁, the select signal SelSig₂ on the select line SelLine₂ represents the result of determining whether one count is higher than the other count, specifically whether CO[3]>CO[4] as also described in relation to FIG. 1a. Since the counter CO[3] in Compute₃ determined that the corresponding data value 4 occurred once and the counter CO[4] in Compute₄ determined that the corresponding data value 1 occurred twice, the evaluation in comparator 172 results in “false”, and the “No” branch is selected, resulting in the signal set {S[4], CA[4], CO[4]} being output on the signal output SigOut₂ of selector SelPar₂ on signal lines 152c, 152a, and 152b, respectively, as shown in FIG. 1c.

As described above, the output of the signal set {S[1], CA[1], CO[1]} on the output SelOut₁ of selector SelPar₁ and the output of {S[4], CA[4], CO[4]} on the output SelOut₂ of selector SelPar₂ will occur temporally overlapping (“substantially simultaneously”) to allow the correct signals to be compared.

FIG. 1d illustrates the final part of determining the most frequent value among the data values represented by the data signals S. The output signals 151a, 151b, and 151c from the signal output SelOut₁ of selector SelPar₁ are provided as input on signal input SelIn1₃ of selector SelPar₃, and the output signals 152a, 152b, and 152c from the signal output SelOut₂ of selector SelPar₂ are provided as input on signal input SelIn1₃ of selector SelPar₃. The output signal from SelPar₃ on the signal output SelOut₃ is determined by the select signal SelSig₃ on the select line SelLine₃. Similarly to select lines SelLine₁ and SelLine₂, the select signal SelSig₃ on the select line SelLine₃ represents whether one count is higher than the other count, specifically whether CO[1]>CO[4]. Since both counts are equal to 2, the comparison in comparator 173 results in “false”. The selector SelPar₃ thus selects the signal set {S[4], CA[4], CO[4]} as output, corresponding to a most frequent value of 1, a comparison signal corresponding to the array {1, 0, 0, 1}, and a count signal CO[4] corresponding to a value of 2. These signals are provided on signal lines 161c, 161a, and 161b, respectively.

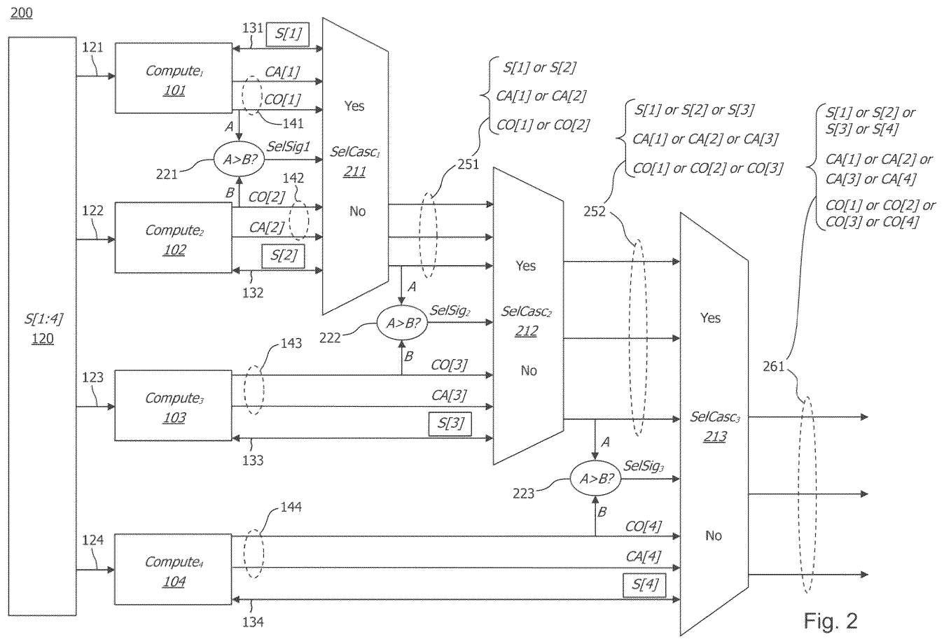

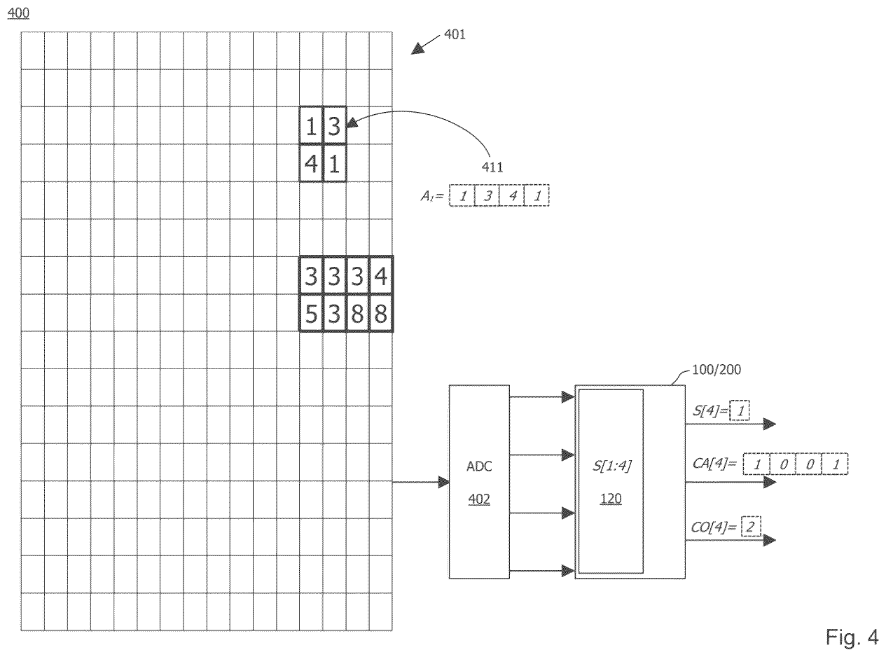

The input data array A₁ might correspond to intensity values (radiation intensities) I[i] measured by corresponding pixels in a CCD device 401, as illustrated in FIG. 4. The electronic system 400 in FIG. 4 comprises the electronic system 100 or 200 described above in relation to FIGS. 1a-1d and FIG. 2, and a CCD 401 coupled to the electronic system 100 or 200 via an analogue-to-digital interface 402 (ADC) for reading out the intensity values in blocks of 4 digital values, which are provided in parallel to the electronic system 100 or 200. The set of pixels 411 shown in FIG. 4 corresponds to the values used in the example in FIGS. 1a-1d, and accordingly, the signal set {S[4], CA[4], CO[4]} is output from the electronic system 400 when the block of 4 pixels 411 is processed by the electronic system 100 or 200. In this way, the electronic system 400 determines from the CCD signal that an intensity of 1 is predominant in the block of pixels 411 of the image signal obtained by the CCD 401.

Referring back to the example in FIGS. 1a-1c, both inputs to the output selector SelPar₃ correspond to the same data value 1. If the data values had been ordered as {1,1,3,4} rather than {1,3,4,1}, the signal set input on the upper signal input SelIn1₃ of SelPar₃ would have been {S[2], CA[2], CO[2]} (corresponding to data value 1), and the signal set input on the lower signal input SelIn2₃ of SelPar1₃ would have been {S[4], CA[4], CO[4]} (corresponding to data value 4). The “Yes” branch in SelPar1₃ would have been selected instead, resulting in the signal set {S[2], CA[2], CO[2]} being output on SelOut₃. The result is of course the same, since the signal set {S[2], CA[2], CO[2]} also corresponds to the most frequent value, 1, which is unique. The count CO[2] and the comparison array CA[2] are also the same.

If the data array had been {1,1,2,2}, the most frequent value would be determined by the electronic system 100 to be 2 with a count of 2, and the comparison array would be {0,0,1,1}. If the same data had been ordered as {2,1,2,1} instead, the most frequent value would be determined to be 1, still with a count of 2. The comparison array would be {0,1,0,1}. This illustrates that the most frequent value is not necessarily unique. This is known in statistics as a multimodal distribution, where the term most frequent value is used even though the several values are “most frequent”. The meaning of the term “most frequent value” is therefore clear to the person skilled in the art.

The example above also illustrates that the determined most frequent value in case of a multimodal distribution depends on the ordering of the data values corresponding to the data signal S.

FIG. 2 illustrates another electronic system 200 in accordance with the invention. The signal input interface may be identical to the interface 120 described in relation to the electronic system 100 illustrated in FIGS. 1a-1d. The function of the signal input interface is to receive the data signals Sand to provide them as input to the computing units 101-104, which may also be identical to the computing units described in relation to the electronic system 100 shown in FIGS. 1a-1d. The principles are the same, but the architecture in the electronic system 200 is different from the electronic system 100 of FIGS. 1a-1d.

The selectors SelCascᵢ in the electronic system 200 are arranged such that each selector except a first selector SelCasc₁ receives a signal set {S[i], CA[i], CO[i]} that has not been evaluated for corresponding to the most frequent value, contrary to the embodiment in FIGS. 1a-1d, in which selector SelPar₃ receives signal sets that have already been compared to other signal sets. Also, the approach in FIGS. 1a-1d is parallel in the sense that 4 signal sets (or more) are evaluated pairwise substantially simultaneously.

In the embodiment in FIG. 2, the computing units Compute₁ work as described above in relation to electronic system 100, providing a count CO[i] and a comparison array CA[i] for each data signal S[i]. The selectors can also be identical to the selectors SelPar₁ described in relation to the embodiment shown in FIGS. 1a-1d. The detailed inputs and outputs are therefore not illustrated or described in detail in relation to the present embodiment. The same applies to the select signals provided by comparators 221, 222, and 223 that compare the counts associated with the various signal sets.

A first selector SelCasc₁ 211 receives two signal sets, {S[1], CA[1], CO[1]} and {S[2], CA[2], CO[2]} similarly to SelPar₁ in FIGS. 1a and 1b. The output is therefore also the same. For an input signal corresponding to the data array A₁={1,3,4,1}, the output signals 251 from SelCasc₁ would be {S[1], CA[1], CO[1]} as described in relation to FIG. 1b, since data value 1 has a count of 2 and data value 3 has a count of 1.

In the electronic system 200 in FIG. 2, the output signal from SelCasc₁ is then used as input to SelCasc₂ 212 together with signal S[3] and the signals CA[3] and CO[3] from Compute₃. In case of the data array A₁={1,3,4,1}, the output signals 252 from SelCasc₂ would be {S[1], CA[1], CO[1]}, since the count corresponding to the signal set {S[3], CA[3], CO[3]} is lower than the count corresponding to the other signal set, {S[1], CA[1], CO[1]}. The comparator 222 would therefore evaluate to true and the “Yes” branch be selected, resulting in the output of SelCasc₂, being {S[1], CA[1], CO[1]}.

Finally, the output signal from SelCasc₂ is used as input to SelCasc₃ 213 together with signals S[4], CA[4], and CO[4](the latter two being provided by Compute₄). In case of the data array A₂={1,3,4,1}, the output signals 261 from SelCasc₃ would be {S[4], CA[4], CO[4]}, since the two counts evaluated by comparator 223 are equal, both corresponding to a count of 2. Accordingly, the comparator 223 would evaluate to false and the “No” branch be selected. This results in output of the signal set {S[4], CA[4], CO[4]}, whereby it has been determined that the data value 1 is the most frequent value. The result is of course identical to the result provided by the electronic system 100 illustrated in FIGS. 1a-1d.

Similarly to the discussion in relation to FIGS. 1a-1d, the electronic system 200 in FIG. 2 is designed such that the transmission lines and processing times allow the outputs and inputs to be provided substantially simultaneously where needed, in particular in order for the different signals to temporally overlap in the selectors. For instance, the transmission time of the signal set {S[3], CA[3], CO[3]} from the interface 120 to SelCasc₂ via lines 123, 133 and 143 and the processing time in Compute₃ should substantially correspond to the transmission time and processing time that ultimately provides an input signal set at the input of the selector SelCasc₂. This includes the transmission time from the interface 120 via signal lines 121 and 122, processing in computing units Compute₁ and Compute₂, selection in selector SelCasc₁, and transmission via lines 251. Once privy to the present disclosure, this is readily appreciated by person skilled in the art.

As seen from the discussion of FIGS. 1a-1d and FIG. 2, the resulting most frequent value obtained is (of course) the same, but it is obtained in two very different ways. Whereas the embodiment 100 in FIGS. 1a-1d operates with parallel comparisons as described above, the selectors in the embodiment 200 shown in FIG. 2 are in a sense cascaded.

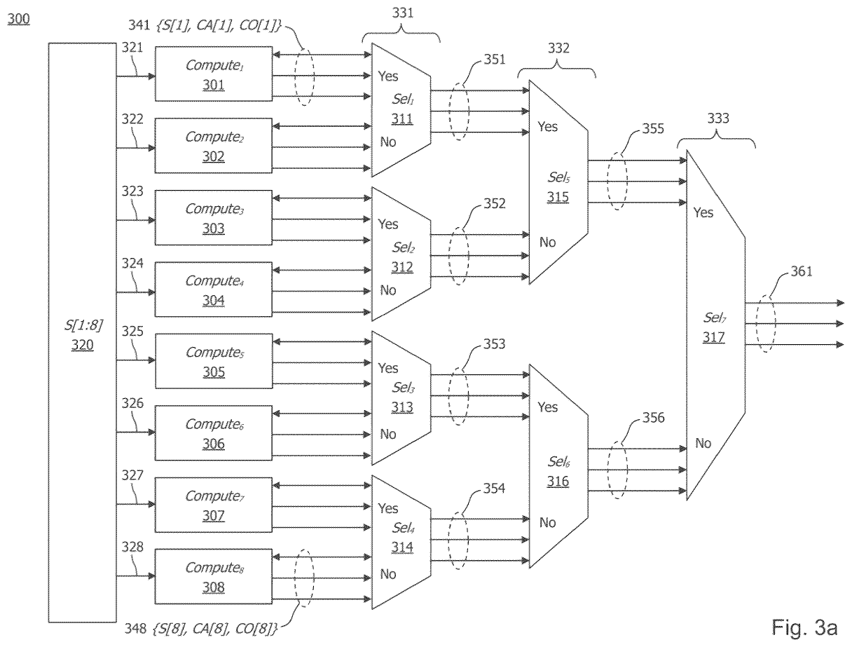

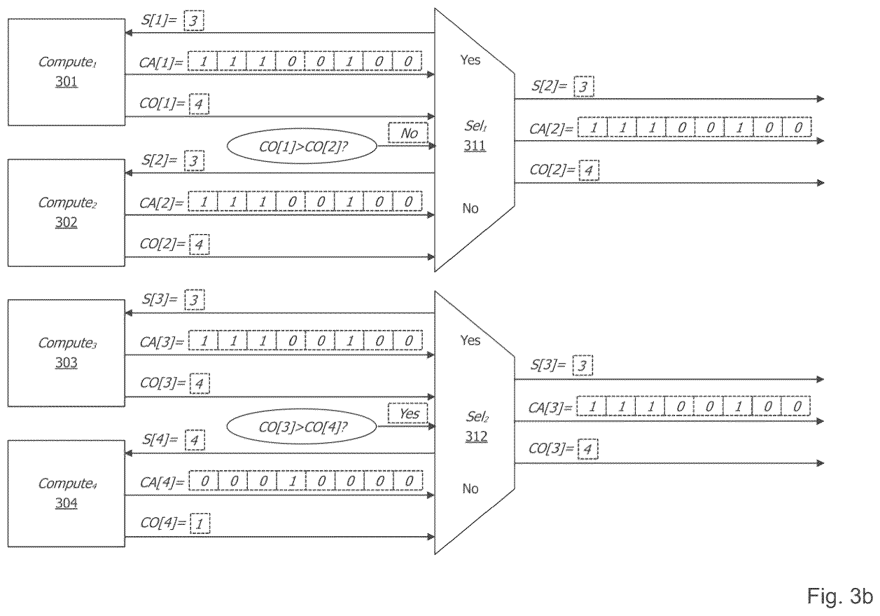

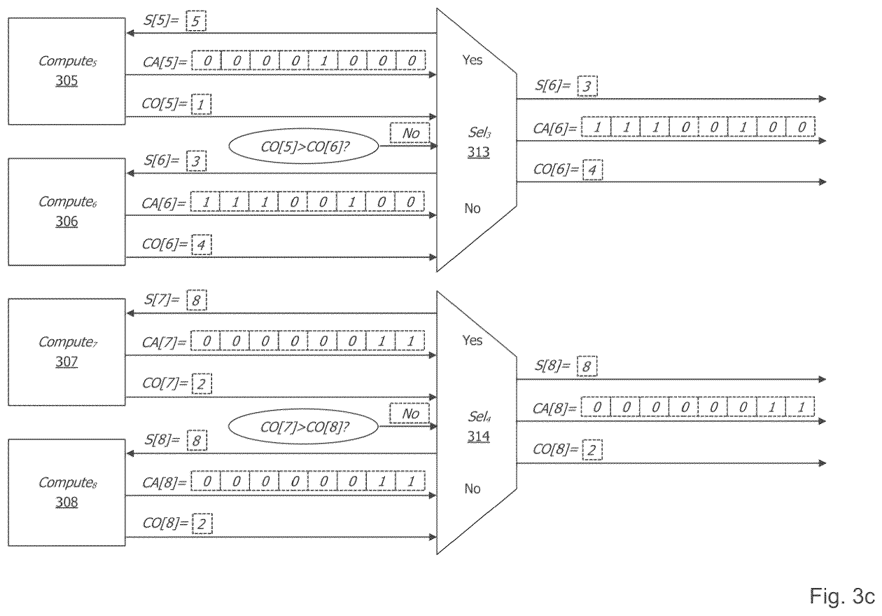

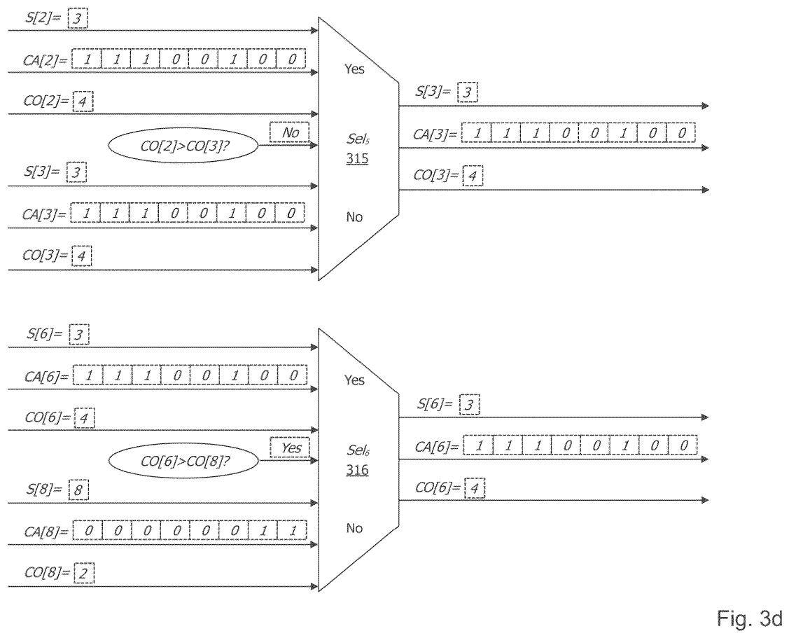

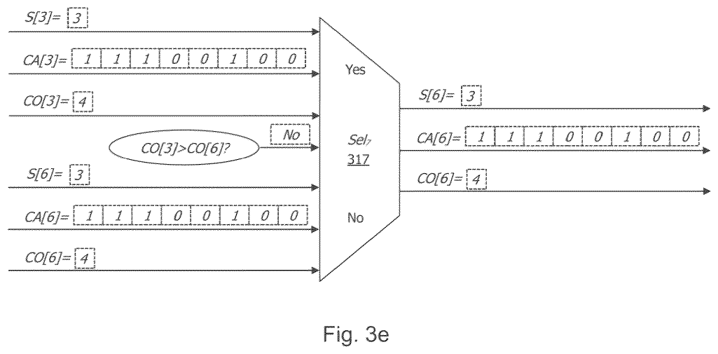

FIG. 3a illustrates another electronic system 300 in accordance with the invention. It is architecturally similar to the electronic system 100 illustrated in FIGS. 1a-1d. Instead of 4 inputs, the electronic system 300 handles 8 input signals S[1:8]. These are received at a signal interface 320 and made available to respective computing units 301-308. The computing units 301-308 use the same principles as the computing units 101-104 of electronic system 100 and 200. Each computing unit 301-308 receives the data signals S[1:8] and a respective individual data signal S[i] for comparison with the data signals S[1:8] and counting, similarly to the description related to FIGS. 1b and 1c. In the present case, each computing unit has 8 comparators in order to compare each of the 8 data signals S with a respective individual data signal S[i]. Similarly, the counters in the computing units in the present embodiment are configured to count based on 8 comparison signals rather than 4 signals as in electronic systems 100 and 200. For simplicity, elements such as select line comparators, select lines, and selector inputs and outputs are not shown explicitly, but it will be readily appreciated that they form part of the electronic system 300 just as described in relation to electronic systems 100 and 200.

The 8 signal sets {S[i], CA[i], CO[i]}, i=1, . . . ,8, are provided pairwise to 4 selectors Selᵢ, i=1, . . . 4. Signal set {S[1], CA[1], CO[1]} and signal set {S[2], CA[2], CO[2]} are provided to selector Sel₁ 311, signal set {S[3], CA[3], CO[3]} and signal set {S[4], CA[4], CO[4]} are provided to selector Sel₂ 312, signal sets {S[5], CA[5], CO[5]} and signal set {S[6], CA[6], CO[6]} are provided to selector Sel₃ 313, and signal set {S[7], CA[7], CO[7]} and signal set {S[8], CA[8], CO[8]} are provided to selector Sel₄ 314. The respective count signals CO[i] from the computing units 301-308 are used as basis for selection in each of the selectors Selᵢ, i=1, . . . , 4, similarly to the processes described in relation to FIGS. 1a-1d and FIG. 2.

In this way, the 8 signal sets are first narrowed down to 4 signal sets output as signals 351, 352, 353, and 354, respectively, from the 4 selectors. One (or more) of these 4 signal sets corresponds to the most frequent data value by virtue of the selectors. The selectors Selᵢ, i=1, . . . , 4, form a first selector subset 321 that narrows the number of signals sets down from/to N/2. In the present example, N=8. The output signals 351, 352, 353, and 354 from the first selector subset 331 are provided pairwise to selectors in a second selector subset 332. In this case, two selectors Selᵢ, i=5,6, are required. The second selector subset 332 narrows the 4 output signal sets from the first selector subset 331 down from 4 to 2. The second selector subset 332 provide output signals 355 and 356, one or more of which corresponds to the most frequent data value.

Finally, these two output signal sets 355 and 356 are provided to a third selector subset 333 which consists of a single selector Sel₇ for evaluating which of the signal sets 355 and 356 correspond to the most frequent value. The selector Sel₇ is furthermore an output selector in the sense that the signal set provided as output 361 by the output selector Sel₇ is guaranteed to correspond to a most frequent value.

The electronic system 300 and its operation is described in more detail with reference to FIGS. 3b-3e in the following.

FIG. 3b focuses on the computing units 101-104 and selectors Sel₁ and Sel₂. The input data signals S in this example correspond to a data array A₂={3,3,3,4,5,3,8,8}. The signals S[i], i=1,2 are input to computing units Computeᵢ, i=1,2, which determine corresponding comparison signals and count signals CA[i] and CO[i], i=1,2. Compute₁ compares the individual signal S[1] across all 8 data signals S. It is determined that the individual data value 3 equals the data values of data array A₂ at indices 1, 2, 3, and 6. Accordingly, the comparison array is {1,1,1,0,0,1,0,0} as illustrated in FIG. 3b. The corresponding count is 4. Similarly, Compute₁ compares the individual signal S[2] across all 8 data signals S. It is determined once again that the individual data value 3 equals the data values of data array A₂ at indices 1, 2, 3, and 6. Accordingly, the comparison array is {1,1,1,0,0,1,0,0}.

The signal sets {S[1], CA[1], CO[1]} and {S[2], CA[2], CO[2]} are provided to selector Sel₁ 311, as described above. The selector Sel₁ outputs signal set {S[2], CA[2], CO[2]} because the corresponding count CO[2](=4) is equal to CO[1](=4), so the “No” branch is selected.

In the same way, the signals S[i], i=3,4 are input to computing units Computeᵢ, i=3, 4, which determine corresponding comparison signals and count signals CA[i] and CO[i], i=3,4. The comparison signals CA[3] and CA[4] and count signals CO[3] and CO[4] are determined by the computing units based on the data signals S and individual data signals S[3] and S[4] as described above. Compute₃ compares the individual signal S[3] across all data signals S, and it is determined once again that the individual data value 3 equals the data values of data array A₂ at indices 1, 2, 3, and 6, and a comparison array of {1,1,1,0,0,1,0,0} is determined as illustrated in FIG. 3b. Compute₄ compares the individual signal S[4] across all data signals S, and it is determined that the individual data value 4 equals the data values of data array A₂ at index 4, and a comparison array of {0,0,0,1,0,0,0,0} is determined as illustrated in FIG. 3b.

The signal sets {S[3], CA[3], CO[3]} and {S[4], CA[4], CO[4]} are provided to selector Sel₂ 312 as described above. The selector Sel₂ outputs signal set {S[3], CA[3], CO[3]} because the corresponding count CO[3](=4) is higher than CO[4](=1).

Similarly, FIG. 3c illustrates the comparison and counting based on input signals S[5], S[6], S[7], and S[8]. The description above relating to FIG. 3b applies mutatis mutandis. The selector Sel₃ will output signal set {S[6], CA[6], CO[6]} because the count CO[5] of the data value 5(S[5 ]) is 1 whereas the count CO[6] of the data value 3(S[6 ]) is 4. Selector Sel₄ will output signal set {S[8], CA[8], CO[8]} because the count CO[7] of the upper input data value 8 is the same as (i.e. not larger than) the count CO[8] of the lower input data value, which is also 8.

In this way, the 8 signals sets have been reduced to 4 signal sets in the first selector subset 331 (see FIG. 3a), namely to {S[2], CA[2], CO[2]} and {S[3], CA[3], CO[3]} as described in relation to FIG. 3b and {S[6], CA[6], CO[6]} and {S[8], CA[8], CO[8]} as described in relation to FIG. 3c.

As illustrated in FIG. 3d, these 4 signal sets are then provided pairwise to the second selector subset 332 shown in FIG. 3a, comprising selectors Sel₅ 315 and Sel₆ 316. The data values input to selector Sels are both 3 (=S[2], S[3]) and thus have the same count 4 (=CO[2], CO[3]). Accordingly, the signal set {S[3], CA[3], CO[3]} is output from Sels. The selector Selo selects the signal set {S[6], CA[6], CO[6]} because the count CO[6] (=4) is higher than the count CO[8] (=2), so the “Yes” branch is selected. As a side note, the subsystem comprising computing units 301-304, selectors 311-312 and selector 315 is itself an embodiment of the invention. Selector 315 is an “output selector” in the sense of the claimed invention for this subsystem. Similarly, the subsystem comprising computing units 305-308, selectors 313-314 and selector 316 is also in itself an embodiment of the invention. Selector 316 is an “output selector” in the sense of the claimed invention for this subsystem. Thus, larger electronic systems in accordance with the invention, having a signal input interface configured to receive for instance 8 or 16 signal sets will inherently comprise a number of subsystems having four inputs for receiving four data values A[m], m=1, . . . , 4, and having three selectors and outputting a signal set that is characterized in that no other data value A[m], m=1, . . . , 4, has a count CO[m] that is higher than the count CO[mₘₐₓ] of the data value A[mₘₐₓ].

Similarly to the first selector subset 331 (Selᵢ, i=1, . . . , 4), which reduces the number of signal sets from 8 to 4, the signals sets output by the first selector subset 331 are reduced from 4 to 2 in the second selector subset 332 (Selᵢ, i=5,6).

As shown in FIG. 3d, a third and final selector subset 333 (see also FIG. 3a), consisting of selector Sel₇, selects between the two input signal sets{S[3], CA[3], CO[3]} and {S[6], CA[6], CO[6]} output by the second selector subset 332. In this case, both sets are identical, and the “No” branch is therefore selected. The output from the output selector Sel₇ is thus the signal set {S[6], CA[6], CO[6]}. The most frequent data value is determined to be 3 (S[6]) with a frequency of 4(CO[6 ]) and a corresponding comparison array which is {1,1,1,0,0,1,0,0}. Again, the comparison array shows where the most frequent value occurs (by 1's) and where not (by 0's).

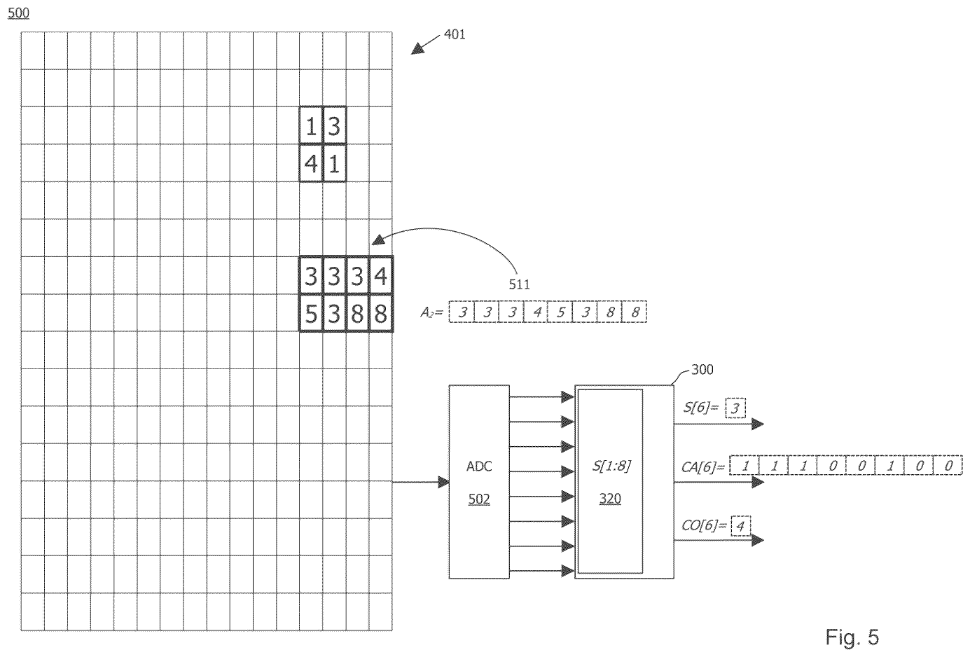

Similarly to the description relating to FIG. 4, the input data array A₂ may correspond to intensity values I[i] measured by corresponding pixels in a CCD device 401, as illustrated in FIG. 5. The electronic system 500 in FIG. 5 comprises the electronic system 300 described above in relation to FIGS. 3a-3e, as well as the CCD 401 coupled to the electronic system 300 via an analogue-to-digital interface 502 for reading out the intensity values in blocks of 8 digital values, which are provided in parallel to the electronic system 300. The set of pixels 511 shown in FIG. 5 corresponds to the values used in the example in FIGS. 3b-3e, and accordingly, the signal set {S[6], CA[6], CO[6]} is output from the electronic system 500 when the block of 8 pixels 511 is processed by the electronic system 300. The result is that an intensity of 3 is determined to be predominant in the block of pixels 511 of the image signal obtained by the CCD 401.

Similarly to the examples provided in relation to a 4-pixel input, a different order of the data values can lead to a different result in case there are two (or more) data values that are both most frequent (multimodal distribution). For instance, processing the data value array {1,3,1,3,1,3,4,4} in the electronic system 300 would result in a most frequent value of 3 and a comparison array of {0,1,0,1,0,1,0,0}, whereas processing a data value array {1,3,1,3,3,1,4,4} results in a most frequent value of 1 and a comparison array of {1,0,1,0,0,1,0,0}, even though the data values are the same, except they occur at other positions in the data array.

Electronic systems in accordance with the invention, such as electronic systems 100, 200, and 300, can also be used in connection with compression of data with or without loss, such as for transmission over a data network.

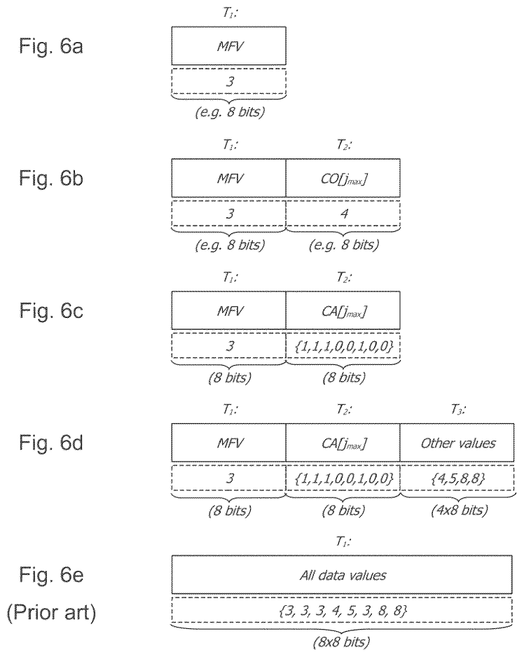

If the only value of interest from each block of pixels is the most frequent value, then rather than sending all data values, only the most frequent value (MFV) for each block is transmitted as part of a transmission signal T wherein the determined most frequent value is represented by a first signal portion T as shown in FIG. 6a. In the example in FIGS. 1b-1d, the most frequent value was 1, and in the example in FIGS. 3b-3e, the most frequent value was 3. FIG. 6a illustrates the value 3 (the most frequent value in the example in FIGS. 3b-3e) being comprised in the transmission portion T₁ which, as shown in FIG. 6a, amounts to only 8 bits in case the resolution is 8 bits.

If the CCD consists of 1920×1080 pixels that are processed by the electronic systems 100 or 200 in blocks of 4 pixels, the number of values to be transmitted is reduced by a factor of 4 from 2073600 to 518400. If the pixels are divided in blocks of 8 rather than 4, as in the electronic system 300, the number of values to be transmitted is 259200.

In some cases, it may be desirable to know not only the most frequent value, but also its frequency within each block. This is achieved by transmitting the most frequent value and its frequency in the transmission signal T as shown in FIG. 6b, which further includes a second transmission portion T₂ comprising the count CO[jₘₐₓ]. In the example in FIGS. 3b-3e, the count of the most frequent value 3 is 4, which is therefore included as illustrated in FIG. 6b. As shown, this amounts to 16 bits to be transmitted for the data array {3, 3, 3, 4, 5, 3, 8, 8}. Alternatively, this is achieved as shown in FIG. 6c, by transmitting the most frequent value MFV in the first signal portion Ti as in FIGS. 6a and 6b and transmitting the comparison array CA[jₘₐₓ] in a second signal portion T₂ of the transmission signal T. In the example in FIGS. 3b-3e, the comparison array CA[jₘₐₓ] is {1,1,1,0,0,1,0,0}, which is therefore included as illustrated in FIG. 6c. In the example in FIG. 6c, this amounts to 16 bits. The latter embodiment has a number of advantages. In case each block processed corresponds to 8 pixels, the comparison array consists of 8 bits. At the receiver side, the number of 1-bits can be counted, which will correspond to the frequency of the most frequent value. In addition, since each element of the comparison array maps to a specific element within the block of pixels, it can be derived which particular pixels have a value equal to the most frequent value. For the array {1,3,4,1} in FIG. 4, it can be derived from the comparison array {1,0,0,1} and the most frequent value 1 that the upper left pixel and the lower right pixel have the value 1. For the comparison array {3,3,3,4,5,3,8,8} used in the example in FIGS. 3b-3e, the most frequent value is 3 and the comparison array is {1,1,1,0,0,1,0,0} and it can readily be derived on the receiver side that the first three pixels in the top row and the second pixel in the bottom row have the most frequent value 3, and this position information takes a single byte (one bit for each of the 8 data values). If the number of pixels in a block is 16, the position information can be transmitted using two bytes (not including additional compression or coding methods being applied).

The order of the information in the transmission can be as desired, as the person skilled in the art will readily appreciate.

In another embodiment, the additional data values other than the most frequent value are also sent, whereby the entire block is transmitted without loss. In this case, the transmission signal T further contains a third signal portion T₃ containing the values that are not most frequent. This is illustrated in FIG. 6d for the data array {3,3,3,4,5,3,8,8}. As shown in FIG. 6d, the most frequent value 3 is sent as portion T₁ together with the comparison array {3,3,3,4,5,3,8,8} sent as portion T₂ as described above, and the other values 4, 5, 8, and 8 are sent in a third signal portion T₃, in that order. At the receiver, the values 4, 5, 8, 8 sent in signal portion T₃ can be mapped to the positions where the comparison array has a value of 0, whereby all information has been transmitted without loss. In the example, instead of sending 8 values, only 5 values need to be sent (5×8 bits) together with the comparison array, the latter requiring one byte in the case of 8 pixels in a block. As also shown in the example in FIG. 6d, this amounts to 48 bits instead of the 64 bits required if the values are sent as shown in FIG. 6e, which does not take advantage of the present method.

If the redundancy is larger, the saving is also larger. On the other hand, if all values are different, the system will need to send more information than necessary, namely both the most frequent value MFV (8 bits) and the comparison array, which is an extra byte. This makes 72 bits in total when transmitting 8 pixels with 8-bit values. This can be overcome by instead sending the data values as normal, which requires 64 bits and not 72 bits. This is illustrated in FIG. 6e.

In the present example where there are 8 pixels with 8-bit values, the system results in a reduced transmission requirement when there are 3 or more pixels with the same value. If 2 pixels have the same value, the amount of data to be sent is the same as if the data values are sent indiscriminately, namely 8 bytes: 1 byte for the most frequent value, 1 byte making up the comparison array, and 6 bytes corresponding to the 6 values other than the determined most frequent value. As described above, the data values in a block can be sent value by value in case the frequency of the most frequent value (i.e. the count CO[i] provided by the electronic system 300) is 1. As described above, this will save the 8 bits corresponding to the superfluous comparison array (in case the number of data values is 8). In all other cases, the amount of data to be transmitted is either the same (in case the count of the most frequent value equals 2) or lower (in case the count of the most frequent value is greater than 2). This depends on the number of pixels in a block and the resolution of the data values.

As will be readily appreciated by the person skilled in the art, the electronic system according to the invention is advantageously realised as an integrated circuit, such as in a silicon chip. The logic described in detail above is realised as a circuit obtained for instance in a process that includes a synthesis process and further processes that translate logic to an actual circuit layout, such as a CMOS-based circuit, for instance based on silicon.

It is also noted that the same logic (“combinatorial”) can be provided in an unlimited number of ways, which is also well known. The layout furthermore depends on the technology node (65 nm process, 40 nm process, . . . ). A definition of the present invention in terms of a physical circuit layout would therefore not be practical, clear, or concise. Thus, the invention has been described and defined partly in logic terms.

The different elements described herein can be provided as single units or can be combined in various ways without departing from the scope of the claims, as the person skilled in the art will readily recognize once privy to the present disclosure. Functional units may be split up in distinct units or combined with other units. Similarly, the transmission signal T can be organised in various ways without departing from the scope of the claims. Furthermore, the different embodiments, such as embodiments 100 and 200, can be combined without departing from the scope of the claims, as can be seen from the independent claim.

### List of References

100: electronic system
101-104: computing units
111-113: selectors arranged in a parallel configuration
120: signal input interface
121-124: input signal lines
131-133: input signal lines
141-144: signal lines connecting computing unit outputs and selector inputs
151-152: signal lines connecting selector outputs to selector inputs
161: output selector output signal lines
200: electronic system
211-213: selectors arranged in a cascade configuration
251-152: signal lines connecting selector outputs to selector inputs
300: electronic system
301-308: computing units
311-317: selectors arranged in a parallel configuration
320: signal input interface
321-328: input signal lines
331-333: selector subsets
341, 348: signal lines connecting computing unit outputs and selector inputs
351-356: signal lines connecting selector outputs to selector inputs
361: output selector output signal lines
400: electronic system
401: image sensor
402: analogue-to-digital converter
411: pixels
500: electronic system
502: analogue-to-digital converter
511: pixels

1-17. (canceled)

18. An electronic system (100, 200, 300, 400, 500) for determining, during use of the electronic system, a most frequent value in a data array A comprising a plurality of N data values A[i], i=1, . . . , N, N≥4, each data value A[i] corresponding to a respective data signal S[i], i=1, . . . , N, the electronic system comprising a first electronic subsystem (100, 200, 300) comprising:
(i) a signal input interface (120, 320) for receiving the data signals S[i], i=1, . . . , N,
(ii) a first set of comparators CA_{i,j} for determining corresponding comparison signals CA[i,j], i=1, . . . , N, j=1, . . . , N, wherein each comparison signal CA[i,j] is representative of whether or not the data value A[i] equals the data value A[j],
(iii) a set of counters COᵢ, i=1, . . . , N, for determining corresponding count signals CO[i], i=1, . . . , N, wherein each count signal CO[i] is representative of the number of occurrences of the data value A[i] among the plurality of data values A,
(iv) a set of selectors Selᵢ, i=1, . . . , M, each selector Selᵢ in the set of selectors comprising:
a first set of signal inputs SelIn1ᵢ configured to receive a first signal set {S[j], CA[j], CO[j]}, where 1≤j≤N and CA[j]={CA[j,1], . . . , CA[j,N]}, and
a second set of signal inputs SelIn2ᵢ configured to receive a second signal set {S[k], CA[k], CO[k]}, where 1≤k≤N, k+j,
a select line SelLineᵢ for receiving a selection signal SelSigᵢ representing whether or not CO[j]>CO[k] as determined by a corresponding select line comparator (171,172,173,221,222,223),
a set of signal outputs SelOutᵢ, the selector Selᵢ being configured to output the signal set {S[j], CA[j], CO[j]} in case SelSigᵢ represents CO[j]>CO[k] and to output either the signal set {S[j], CA[j], CO[j]} or the signal set
{S[k], CA[k], CO[k]} in case SelSigᵢ represents CO[j]≤CO[k], the set of selectors Selᵢ, i=1, . . . , M, including an output selector Selₒᵤₜ, being interconnected such that the output selector Selₒᵤₜ provides as output signals on its set of signal outputs the signal set {S[jₘₐₓ], CA[jₘₐₓ], CO[jₘₐₓ]}, 1≤jₘₐₓ≤N, wherein the signal set {S[jₘₐₓ], CA [jₘₐₓ], CO[jₘₐₓ]} is characterized in that no other data value A[k], k=1, . . . , N, has a count CO[k] that is higher than the count CO[jₘₐₓ] of the data value A[jₘₐₓ].

19. An electronic system in accordance with claim 18, wherein each selector Selᵢ, i=1, . . . , M, is configured to output the signal set {S[j], CA[j], CO[j]} in case SelSigᵢ represents CO[j]=CO[k].

20. An electronic system in accordance with claim 18, wherein each selector Selᵢ, i=1, . . . , M, is configured to output the signal set {S[k], CA[k], CO[k]} in case SelSigᵢ represents CO[j]=CO[k].

21. An electronic system in accordance with claim 18, wherein log₂(N) is an integer and wherein each selector of a first selector subset SelSub1ᵢ, i=1, . . . , N/2, of the set of selectors is arranged to receive a respective pair of signal sets of the N signal sets {S[j], CA[j], CO[j]}, j=1, . . . , N, on its first set of signal inputs and its second set of signal inputs, respectively, whereby the first selector subset outputs N/2 signal sets, at least one of which corresponds to the data value A[jₘₐₓ].

22. An electronic system in accordance with claim 21, wherein each selector of a second selector subset SelSub2ᵢ, i=1, . . . , N/4, of the set of selectors is arranged to receive a respective pair of the N/2 signal sets output by the first selector subset SelSub1ᵢ, i=1, . . . , N/2, whereby the second selector subset outputs N/4 signal sets, at least one of which corresponds to the data value A[jₘₐₓ].

23. An electronic system in accordance with claim 22, wherein N≥8 and wherein the set of selectors further comprises one or more further selector subsets SelSub₁ arranged in series with one another and with the second selector subset, each further selector subset providing half as many output signals sets on its signal outputs as said each further selector subset receives on its signal inputs, at least one of the output signal sets from each further selector subset corresponding to the signal set {S[jₘₐₓ], CA[jₘₐₓ], CO[jₘₐₓ]}, a final further selector subset comprising the output selector Selₒᵤₜ, whereby the signal sets {S[j], CA[j], CO[j]}, j=1, . . . , N, are progressively reduced by the electronic system to the single signal set {S[jₘₐₓ], CA[jₘₐₓ], CO[jₘₐₓ]} which is output from the signal outputs of the output selector Selₒᵤₜ.

24. An electronic system in accordance with claim 18, wherein the set of selectors comprises a first selector SelCasc₁ being arranged to receive a first pair of signal sets of the signal sets {S[j], CA[j], CO[j]}, j=1, . . . , N, the set of selectors further comprising a set of further selectors SelCascᵢ, i=2, . . . , N−1, each of the further selectors SelCascᵢ, i=2, . . . , N−1, being arranged to receive the output signals from a preceding selector SelCascᵢ₋₁, i=2, . . . , N−1, on its first set of signal inputs and to receive, on its second set of signal inputs, a signal set among {S[], CA[], CO[]}, j=1, . . . , N, that has not been provided as input to the set of selectors, until all signal sets have been provided as input to a selector of the set of selectors, whereby the signal set {S[jₘₐₓ], CA[jₘₐₓ], CO[jₘₐₓ]} is provided as output on the signal outputs of the selector SelCasc_{N-1} of the set of selectors.

25. An electronic system in accordance with claim 18, further comprising:
(i) an image sensor (401) comprising a plurality of pixels p[i], i=1, . . . , I, I≥4, for capturing an image signal, the image signal representing a set of intensity values I[i], i=1, . . . , I, each intensity value I[i], i=1, . . . , I, representing an amount of radiation captured by a corresponding pixel p[i], i=1, . . . , I, of the image sensor,
(ii) an analogue-to-digital interface (ADC, 402, 502), the ADC being arranged to receive the image signal from the image sensor and to provide a corresponding digital image signal representing the intensity values I[i], i=1, . . . , I, captured by the corresponding pixels p[i], i=1, . . . , I, in the image sensor, the ADC further comprising an ADC output interface connected to the signal input interface (120, 320) to provide at least a part of the digital image signal to the electronic system.

26. An electronic system in accordance with claim 25, wherein the ADC is configured to output, on the ADC output interface, a part of the digital image signal corresponding to N of the intensity values in parallel.

27. An electronic system in accordance with claim 26, wherein the extracted N intensity values from the intensity values I[i], i=1, . . . , I, correspond to a subset of N pixels p[i] that are contiguously arranged in the image sensor.

28. An electronic system in accordance with claim 27, wherein the N pixels p[i] are arranged in a two-dimensional array of L×P pixels, where L, P>2, such as L, P≥3, such as L, P≥4.

29. An electronic system in accordance with claim 26, wherein the ADC is further configured to sequentially provide the intensity values I[i], i=1, . . . , I, in blocks of N intensity values to the first electronic subsystem, the electronic system further comprising a transmitter system coupled to the first electronic subsystem and being configured to receive the output signals from the output selector Selₒᵤₜ, the transmitter system further being configured to provide a transmission signal T comprising a first signal portion T₁ that represents the most frequent value A[jₘₐₓ].

30. An electronic system in accordance with claim 29, wherein the transmission signal T comprises a second signal portion T₂ representing the comparison array CA[jₘₐₓ].

31. An electronic system in accordance with claim 29, wherein the transmission signal T comprises a third signal portion T₃ representing the distinct data values of the data array A other than the most frequent value A[jₘₐₓ].

32. An electronic system in accordance with claim 18, wherein the first electronic subsystem is comprised in an application-specific integrated circuit (ASIC) comprising:
(i) the signal input interface,
(ii) the first set of comparators,
(iii) the set of counters,
(iv) the set of selectors,
(v) the select line comparators, and
(vi) a signal output interface configured to provide the output signals {S[jₘₐₓ], CA[jₘₐₓ], CO[jₘₐₓ]} from the output selector Selₒᵤₜ.

33. A method for determining a most frequent value in a data array A comprising a plurality of N data values A[i], i=1, . . . , N, N≤4, each data value A[i] corresponding to a respective data signal S[i], i=1, . . . , N, the method being carried out in an electronic system (100, 200, 300), the method comprising steps of:
(i) receiving the data signals S[i], i=1, . . . , N, on a signal input interface of the electronic system,
(ii) determining a set of comparison signals CA[i,j], i=1, . . . , N, j=1, . . . , N, wherein each comparison signal CA[i,j] is representative of whether or not the data value A[i] equals the data value A[j],
(iii) determining a set of count signals CO[i], i=1, . . . , N, wherein each count signal CO[i] is representative of the number of occurrences of the data value A[i] among the plurality of data values A; the data signals, the comparison signals, and the count signals forming a plurality of signal sets {S[i], CA[i], CO[i]}, i=1, . . . , N, where CA[i]={CA[i, 1], . . . , CA[i, N]},
(iv) in a set of selectors, carrying out a number of signal selections, wherein each of the signal sets {S[i], CA[i], CO[i]}, i=1, . . . , N, is selected or discarded based on a comparison with at least one other signal set {S[j], CA[j], CO[j]}, 1≤j≤N, i≠j, wherein the comparison is based on the respective counts CO[i] and CO[j], each selection comprising:
in case CO[i]>CO[j], selecting the signal set {S[i], CA[i], CO[i]} for comparison with another signal set {S[k], CA[k], CO[k]}, i≠j≠k, in one of the selectors and discarding the signal set {S[j], CA[j], CO[j]}, or
in case CO[i]≤CO[j], selecting one of the signal sets {S[i], CA[i], CO[i]} and {S[j], CA[j], CO[j]} for comparison with another signal set {S[k], CA[k], CO[k]}, 1≤k≤N, i≠j≠k, in one of the selectors and discarding the other of the signal sets {S[i], CA[i], CO[i]} and {S[j], CA[j], CO[j]},
(v) continuing step (iv) until all except a single signal set {S[jₘₐₓ], CA[jₘₐₓ], CO[jₘₐₓ]}, 1≤jₘₐₓ≤N, have been discarded in one of the comparisons, and
(vi) providing the signal set {S[jₘₐₓ], CA[jₘₐₓ], CO[jₘₐₓ]} on a signal output interface of the electronic system.

34. A method in accordance with claim 33, wherein the data signals S correspond to respective N signals captured by an image sensor, wherein each of the N signals represent an amount of radiation captured by respective N pixels in the image sensor, such as N contiguous pixel in the image sensor.
